(19) United States
(12) Patent Application Publication
(10) Pub. No.: US 2008/0081612 A1
(43) Pub. Date: Apr. 3, 2008

(54) Method and apparatus for updating standard time in mobile communication terminal

(75) Inventors: Jung Kuk Seo, Gumi-si (KR); Sang Jae Bae, Gumi-si (KR); Chang Yong Choi, Daegu Metropolitan City (KR); Sung Gi Baek, Daegu Metropolitan City (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/903,110

(22) Filed: Sep. 20, 2007

(30) Foreign Application Priority Data
Sep. 29, 2006 (KR) 2006-0096218

(51) Int. Cl. H04Q 7/20

(52) U.S. Cl. 455/425

(57) ABSTRACT

A method and apparatus for updating a regional reference time of a mobile communication terminal by a regional standard time difference according to a Network Identity and Time Zone (NITZ) information change in an asynchronous transfer mode-based mobile communication system are provided. The method of updating a regional reference time of a mobile communication terminal includes determining whether new regional standard time information is received and calculating, if a regional standard time information is changed, a regional standard time difference, which may have a positive or negative value; and resetting the regional reference time by adding the regional standard time difference to a preset regional reference time.

### CLAIMS OF PRIORITY

This application claims priority to an application entitled “METHOD AND APPARATUS FOR UPDATING STANDARD TIME IN MOBILE COMMUNICATION TERMINAL,” filed in the Korean Intellectual Property Office on Sep. 29, 2006 and assigned Serial No. 2006-0096218, the contents of which are incorporated herein by reference.

### BACKGROUND OF THE INVENTION

1. Field of the Invention

The present invention relates to a method and apparatus for updating a regional reference time in a mobile communication terminal, and more particularly, to a method and apparatus for updating the regional reference time by a regional standard time difference according to a Network Identity and Time Zone (hereinafter, NITZ) information change in an asynchronous transfer mode-based mobile communication system.

2. Description of the Related Art

In general, in an asynchronous transfer mode-based mobile communication system, when a mobile communication terminal receives time zone information (i.e. a standard time of a specific region) from a base station of a Public Land Mobile Network (hereinafter, PLMN) and moves to another time zone, the mobile communication terminal receives the change in the regional standard time information from the new base station. Accordingly, a user of the mobile communication terminal must directly adjust a regional reference time thereof.

In order to avoid the involvement of the user in the asynchronous transfer mode-based mobile communication system, a method of receiving NITZ information from the PLMN and updating the regional reference time is used.

The mobile communication terminal receives the NITZ information from the PLMN in the asynchronous transfer mode-based mobile communication system at the following occurrence:

1) When the mobile communication terminal is registered in the PLMN; 2) when the mobile communication terminal moves to another time zone; 3) when a time zone within the PLMN is changed (i.e. PLMN contains at least 2 time zones); 4) when the network identity of the PLMN is changed; and 5) when the mobile communication terminal sets (connects) a call.

A method of updating the regional reference time of a mobile communication terminal in a conventional asynchronous transfer mode-based mobile communication system displays, when the mobile communication terminal receives the NITZ information from the PLMN, a notification message, “NITZ information is received; and changes a system time of the mobile communication terminal according to new NITZ information?”, on the screen of a display unit in the mobile communication terminal. The mobile communication terminal then automatically updates, if the user of the mobile communication terminal inputs an instruction to change a system time thereof (e.g. selects a “yes” instruction key), the system time thereof based on the new NITZ information is rebooted.

However, in the method of updating the regional reference time of the mobile communication terminal in the conventional asynchronous transfer mode-based mobile communication system, in order to update the regional reference time of the mobile communication terminal according to new NITZ information, the mobile communication terminal must be rebooted, whereby it is inconvenient to use the mobile communication terminal.

### SUMMARY OF THE INVENTION

The present invention has been made in an effort to solve the above problems and provides additional advantages, by providing a method and apparatus that can calculate a difference between regional standard times of a PLMN from a difference between current NITZ information and existing NITZ information in which the mobile communication terminal receives and automatically changes a regional reference time of the mobile communication terminal by the time difference in an asynchronous transfer mode-based mobile communication system.

Another aspect of the present invention is to provide a method and apparatus that can automatically change, when NITZ information of the mobile communication terminal is changed, a regional reference time of a mobile communication terminal without rebooting the mobile communication terminal in an asynchronous transfer mode-based mobile communication system.

In accordance with an aspect of the present invention, a method of updating a regional reference time of a mobile communication terminal in an asynchronous transfer mode-based mobile communication system includes: determining whether new regional standard time information is received and calculating, if a regional standard time information is changed, a regional standard time difference, which may have a positive or negative value; and resetting the regional reference time by adding the regional standard time difference to a preset regional reference time.

In accordance with another aspect of the present invention, an apparatus for updating a regional reference time of a mobile communication terminal in an asynchronous transfer mode-based mobile communication system includes: a controller for setting regional standard time information, received from a base station of a region in which the mobile communication terminal is positioned by connecting to the mobile communication system, to a regional reference time of the mobile communication terminal; and a regional standard time information processor for resetting the regional reference time by adding a regional standard time difference related to a change of the regional standard time information to the regional reference time of the mobile communication terminal.

### BRIEF DESCRIPTION OF THE DRAWINGS

The above features and advantages of the present invention will be more apparent from the following detailed description in conjunction with the accompanying drawings, in which:

FIG. 1 is a diagram illustrating the position movement of a mobile communication terminal in an asynchronous transfer mode-based mobile communication system according to an embodiment of the present invention;

FIG. 2 is a diagram illustrating a configuration of a mobile communication terminal according to an embodiment of the present invention; and

FIG. 3 is a flowchart illustrating a method of updating a regional reference time in a mobile communication terminal according to an embodiment of the present invention.

### DETAILED DESCRIPTION OF THE INVENTION

Now, embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

A mobile communication terminal according to an embodiment of the present invention includes a photographing function, mobile communication function, digital broadcasting receipt function, and data processing function.

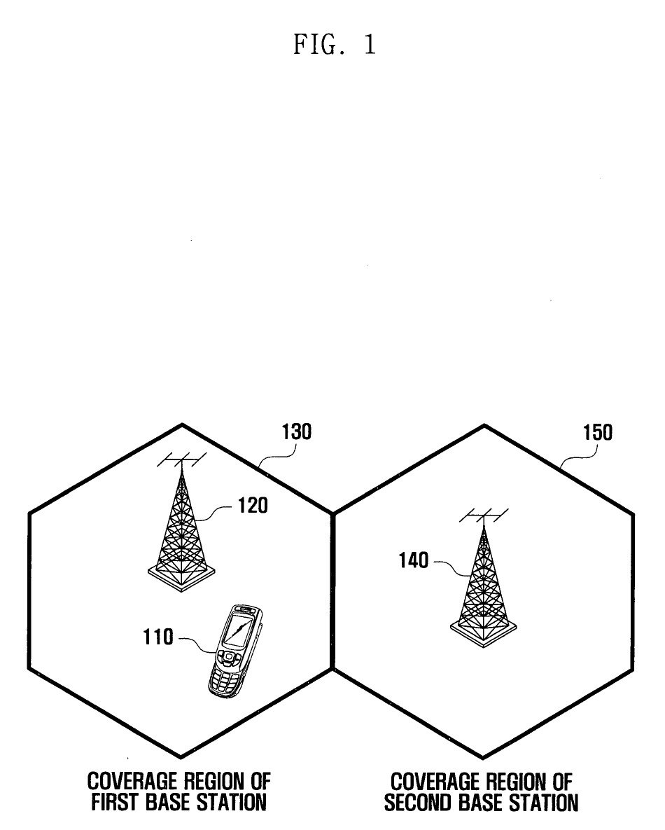

FIG. 1 is a diagram illustrating the position movement of a mobile communication terminal in an asynchronous transfer mode-based mobile communication system according to an embodiment of the present invention. As shown, when the mobile communication terminal 110 moves from a coverage region 130 (or a cell region) of a first base station 120 to a coverage region 150 of a second base station 140, which have a different regional standard time within a PLMN, the mobile communication terminal 110 receives new NITZ information from the second base station 140 and outputs a “yes” or “no” selection screen with a notification message, “NITZ information is received; and changes a system time of the mobile communication terminal according to new NITZ information?”, on a screen of a display unit thereof. If the user of the mobile communication terminal 110 selects a “yes” instruction key, a controller of the mobile communication terminal 10 automatically updates a system time of the mobile communication terminal 110 according to the new NITZ information.

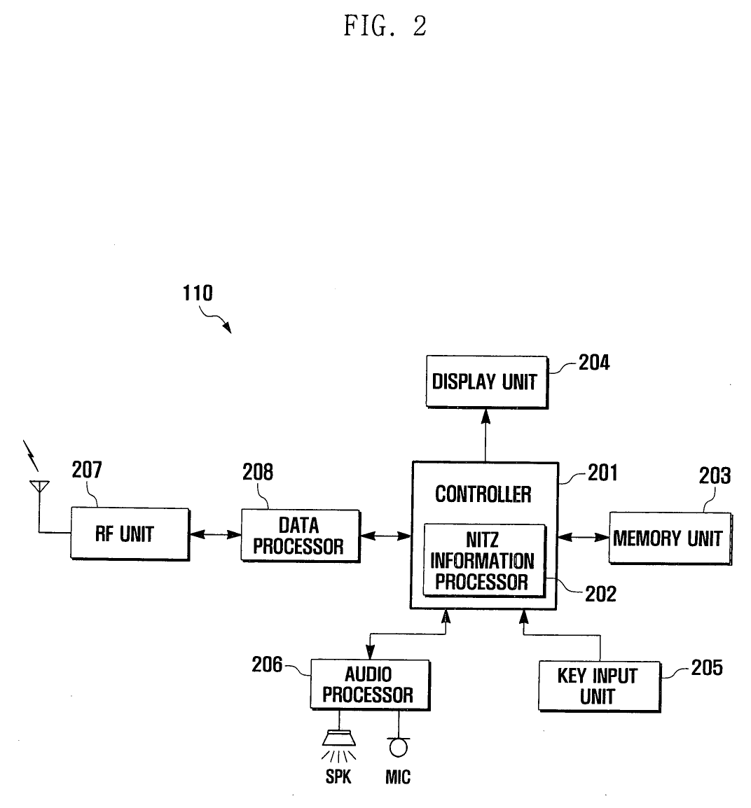

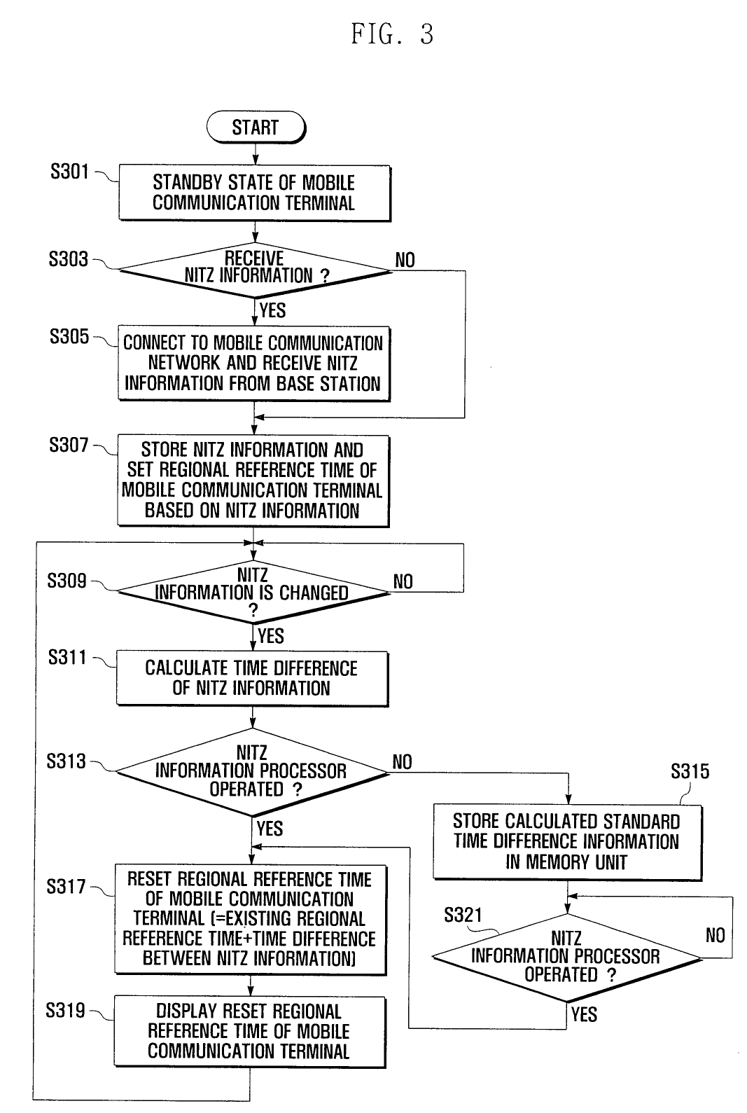

A method and apparatus for automatically updating a reference time in the mobile communication terminal 110 are described in detail hereinafter with reference to FIGS. 2 and 3.

FIG. 2 is a diagram illustrating a configuration of the mobile communication terminal 110 according to an embodiment of the present invention. As shown, the mobile communication terminal 110 includes a controller 201, NITZ information processor 202, memory unit 203, display unit 204, key input unit 205, audio processor 206, radio frequency (RF) unit 207, and data processor 208.

In operation, the controller 201 performs a function of controlling the entire operation of the mobile communication terminal 110 and is connected to the memory unit 203, display unit 204, key input unit 205, audio processor 206, and data processor 208 to control the exchange and processing of received data and setting of a call.

Further, the controller 201 sets regional standard time information received from a base station of a region in which the mobile communication terminal 110 is positioned to a regional reference time of the mobile communication terminal 110 by connecting to an asynchronous transfer mode-based mobile communication system.

The NITZ information processor 202 is a regional standard time information processor for resetting a regional reference time of the mobile communication terminal 110 by adding a time difference of regional standard times, related to a change of the regional standard time information, to a regional reference time of the mobile communication terminal 110. The NITZ information processor 202 includes a calculating unit for determining whether the mobile communication terminal 110 receives new regional standard time information (NITZ information) and for calculating, if the regional standard time information is changed, a regional standard time difference, and a resetting unit for resetting the regional reference time of the mobile communication terminal 110 by adding the regional standard time difference to the regional reference time of the mobile communication terminal 110.

The RF unit 207 performs a wireless communication function of the mobile communication terminal 110. Further, the RF unit 207 receives NITZ information transmitted by a base station in the coverage area where the mobile communication terminal 10 is positioned.

The key input unit 205 has keys for inputting telephone numbers including numeral and character information as well as function keys for setting various functions.

The display unit 204 displays a multimedia image and data broadcasting information received in a digital broadcasting mode on a screen. Further, the display unit 204 outputs an inquiry on whether the NITZ information is changed, and whether a system time of the mobile communication terminal 110 is updated according to the change.

The memory unit 203 can store system files for operating the mobile communication terminal 10 and a large amount of multimedia files and data broadcasting information related to the receipt of digital mobile broadcasting. Further, the memory unit 203 stores the received NITZ information.

The audio processor 206 includes a codec (coder/decoder) that includes a data codec for processing packet data and an audio codec for processing an audio signal such as a voice. Further, the audio processor 206 converts a digital signal received by the RF unit 207 to an analog signal through the audio codec and plays the signal through a speaker SPK, and converts an analog signal input through a microphone MIC to a digital signal through the audio codec and outputs the signal to the controller 201.

FIG. 3 is a flowchart illustrating a method of updating a regional reference time in the mobile communication terminal 110 according to an embodiment of the present invention.

The mobile communication terminal 110 starts in a standby state where a power source is turned on (S301). The standby state is a state before the mobile communication terminal 110 connects to a mobile communication network.

The controller 201 determines whether NITZ information is received through the RF unit 207 (S303). The NITZ information is communication network identity and time zone information in an asynchronous transfer mode-based mobile communication system, and includes a network identity signal and standard time information of the corresponding base station for displaying the coverage of a base station where the mobile communication terminal 110 is currently positioned. The NITZ information is transmitted to the mobile communication terminal 110 in a standby state by the corresponding base station, even when no call is set between the base station and the mobile communication terminal 110.

If NITZ information is not received through the RF unit 207, the controller 201 is connected to a mobile communication network by setting a call to the base station of the currently positioned region and receives NITZ information from the base station (S305). The mobile communication network is an asynchronous transfer mode-based mobile communication system and includes, for example, a European GSM type mobile communication network.

The controller 201 stores the received NITZ information in the memory unit 203 and sets a regional reference time of the mobile communication terminal 110 based on the NITZ information (S307). Accordingly, for example, entire functions of the mobile communication terminal 110, such as an alarm time and a broadcasting time of digital mobile broadcasting, operate based on the regional reference time.

Steps S301 to S307 may be preliminary steps of updating a reference time according to the embodiment of the present invention. That is, it is assumed that the mobile communication terminal 110 has already received, stored the NITZ information, and set a reference time. An operation of updating a reference time according to the embodiment of the present invention is described hereinafter.

The controller 201 determines whether the NITZ information is changed (S309). That is, the controller 201 determines whether new NITZ information different from the last received NITZ information is received.

Particularly, in the embodiment of the present invention, the mobile communication terminal 110 receives the NITZ information from the PLMN when 1) the mobile communication terminal 110 registers in the PLMN (i.e. when use permission of the mobile communication terminal 110 is received from the mobile communication network by transmitting user information and terminal information registered in an SIM card of the mobile communication terminal 110 to the mobile communication network), 2) the mobile communication terminal 110 sets (connects) a call to the PLMN, and 3) the mobile communication terminal 110 moves to a coverage region of a base station having a regional standard time zone different from a current regional standard time zone. Note that scenario 3) frequently occurs in the embodiment of the present invention.

If the new NITZ information is not changed at step S309, the process returns to step S303, and a system of the mobile communication terminal 110 continues to operate based on the existing NITZ information.

If the NITZ information is changed at step S309, the NITZ information processor 202 calculates a time difference of the NITZ information (S311). That is, a standard time difference is calculated by comparing standard time information of the changed NITZ information and standard time information of the existing NITZ information. For example, when a user of the mobile communication terminal 110 moves from a region in which 08:00 GMT is the regional standard time of the corresponding base station to a region in which 09:00 GMT is the regional standard time of the corresponding base station, the standard time difference is (+) one hour, and when the user of the mobile communication terminal 110 moves from a region in which 08:00 GMT is the regional standard time of the corresponding base station to a region in which 07:00 GMT is the regional standard time of the corresponding base station, the standard time difference is (−) one hour.

When a time difference of the NITZ information is calculated, the controller 201 determines whether the NITZ information processor 202 is operated (S313). This is because a function of the NITZ information processor 202 for processing the NITZ information can be disabled by the selection of a user of the mobile communication terminal. That is, when the user of the mobile communication terminal 110 does not want the automatic change of the regional reference time thereof, for example, when the user temporarily moves to a region having a different regional standard time zone or when the user wants to sustain the regional reference time of the mobile communication terminal 110 as a standard time of the originally positioned region, the user can set the function of the NITZ information processor 202 to be stopped through an appropriate key input instruction.

If the NITZ information processor 202 is not operated, the controller 201 stores the calculated standard time difference information in the memory unit 203 and sustains the existing reference time of the mobile communication terminal 110 (S315).

If the NITZ information processor 202 is operated, the NITZ information processor 202 resets the regional reference time of the mobile communication terminal 110 using the calculated standard time difference (S317). That is, for example, when the calculated standard time difference is (+) one hour, the regional reference time of the mobile communication terminal 110 increases by one hour, and when the calculated standard time difference is (−) one hour, the regional reference time of the mobile communication terminal 110 decreases by one hour.

Accordingly, when the position of the mobile communication terminal 110 changes to a region having a different regional standard time, as changed NITZ information is received, the regional reference time of the mobile communication terminal 110 is automatically reset based on the changed NITZ information without rebooting the mobile communication terminal.

A current time output to the display unit 204 of the mobile communication terminal 110 is also changed and displayed according to the reset regional reference time of the mobile communication terminal 110 (S319). For example, when the calculated standard time difference is (+) one hour, the current time displayed increases by (+) one hour, and when the calculated standard time difference is (−) one hour, the current time displayed decreases by (−) one hour.

The controller 201 determines whether the NITZ information processor 202 is operated (S321). If the NITZ information processor 202 is operated, the controller 201 can reset the regional reference time of the mobile communication terminal 110 using standard time difference information stored in the memory unit 203. That is, the controller 201 determines whether a function of the NITZ information processor 202 is converted from a disable state to an enable state. If a function of the NITZ information processor 202 is converted from a disable state to an enable state, the controller 201 performs a process of steps S317 to S319 and resets the regional reference time of the mobile communication terminal 110, and changes and displays a current time of the mobile communication terminal 110 according to the reset regional reference time.

As described above, in a method of updating a regional reference time of the mobile communication terminal 110 in the conventional asynchronous transfer mode-based mobile communication system, there is a problem that the mobile communication terminal 110 must be rebooted in order to automatically update the regional reference time of the mobile communication terminal 110 according to new NITZ information.

According to the present invention, a regional reference time of the mobile communication terminal can be automatically reset without rebooting the mobile communication terminal by calculating the difference between regional standard times from the difference between newly changed NITZ information and existing NITZ information received by a mobile communication terminal in an asynchronous transfer mode-based mobile communication system and changing the regional reference time of the mobile communication terminal by the calculated difference.

Although exemplary embodiments of the present invention have been described in detail hereinabove, it should be clearly understood that many variations and modifications of the basic inventive concepts herein taught that may appear to those skilled in the present art will still fall within the spirit and scope of the present invention, as defined in the appended claims.

What is claimed is:

1. A method of updating a regional reference time of a mobile terminal in an asynchronous transfer mode-based mobile communication system, comprising:
determining whether a new regional standard time information is received;
calculating a regional standard time difference if the new regional standard time information is received; and
resetting the regional reference time by adding the regional standard time difference to a preset regional reference time.

2. The method of claim 1, further comprising, before calculating the regional standard time difference:
receiving a regional standard time information corresponding to a region where the mobile terminal is currently positioned; and
setting the regional reference time based on the received regional standard time information.

3. The method of claim 2, wherein receiving the regional standard time information comprises:
setting a call to a base station of a region where the mobile terminal is currently positioned; and
receiving the regional standard time information from the base station to which the call is set.

4. The method of claim 2, wherein setting the regional reference time comprises:
storing the received regional standard time information; and
setting the regional reference time according to the stored regional standard time information.

5. The method of claim 1, wherein calculating the regional standard time difference comprises:
determining whether the regional standard time information is changed;
calculating, if the regional standard time information is changed, the regional standard time difference between the new regional standard time information and the regional standard time information before the regional standard time information changed; and
determining whether a function of processing the changed regional standard time information is operated.

6. The method of claim 5, further comprising storing, if the function of processing the regional standard time information is not operated, the regional standard time difference between the new regional standard time information and the regional standard time information before the regional standard time information changes.

7. The method of claim 6, further comprising resetting, if the function of processing the regional standard time information is operated, the regional reference time using the stored regional standard time difference.

8. The method of claim 1, wherein resetting the regional reference time comprises:
setting a new regional reference time by adding the regional standard time difference to the regional reference time of the mobile communication terminal; and
outputting the set regional reference time to a display unit of the mobile communication terminal.

9. The method of claim 1, wherein the regional standard time information is a public land mobile network identity and time zone information.

10. An apparatus for updating a regional reference time of a mobile communication terminal in an asynchronous transfer mode-based mobile communication system, comprising:
a controller for setting a regional standard time information, received from a base station of a region in which the mobile communication terminal is positioned, by connecting to the mobile communication system to a regional reference time of the mobile communication terminal; and
a regional standard time information processor for resetting the regional reference time by adding a regional standard time difference related to a change of the regional standard time information to the regional reference time of the mobile communication terminal.

11. The apparatus of claim 10, wherein the regional standard time information processor comprises:
a calculating unit for determining whether the mobile communication terminal receives a new regional standard time information and for calculating, if the regional standard time information is changed, the regional standard time difference; and
a resetting unit for resetting the regional reference time of the mobile communication terminal by adding the regional standard time difference to the regional reference time of the mobile communication terminal.

12. The apparatus of claim 11, wherein the regional standard time information is a public land mobile network identity and time zone information.

13. The apparatus of claim 11, further comprising a display for displaying the set regional reference time.
